(19) United States
(12) Patent Application Publication
(10) Pub. No.: US 2006/0279533 A1
(43) Pub. Date: Dec. 14, 2006

(54) ELECTRONIC BOOK READING APPARATUS

(76) Inventor: Kuan-Hong Hsieh, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/308,778

(22) Filed: May 3, 2006

(30) Foreign Application Priority Data
Jun. 10, 2005 (CN) 200510035300.4

(51) Int. Cl. G09G 5/00

(52) U.S. Cl. 345/156

(57) ABSTRACT

An electronic book reading apparatus mainly includes a user interface, an operation controlling unit, and a display unit. The user interface allows a user to flip an appropriate number of pages of a displayed electronic book. The user interface includes a plurality of sensing units for generating sensing signals in response to the user's flipping operations. The operation controlling unit is used for determining a direction of the flipping operations and generating a direction signal according to the sensing signals. The display unit receives the direction signal, flips the appropriate number of pages of the electronic book in a corresponding direction according to the received direction signal, and displays the resulting page of the electronic book.

### TECHNICAL FIELD

The present invention relates to electronic book reading apparatuses, and particularly to an electronic book reading apparatus having the feel of operating real paper books.

### GENERAL BACKGROUND

As computer technology have developed and grown in popularity, electronic books and publications have also increased and are finding widespread acceptance in the general public. As opposed to books in paper form, electronic books are read on a corresponding electronic book reading apparatus that displays pages of information just as they would appear in a paper book, thereby reducing costs in printing, binding, warehousing, and distributing.

The electronic book reading apparatus is widely known. A typical one is a hand-held book device including a display device to display the text data and a user interface that allows a user to navigate through the text data. The display device and the user interface are incorporated in a hand-held housing to facilitate portability of the electronic book reading device.

Furthermore, many electronic book reading devices have the user interface in the form of one or more buttons. The user is required to depress a selected button to flip over pages. However, this operation manner is not intuitive, and thus the user may feel bothered with this operation manner.

What is needed, therefore, is an electronic book reading apparatus which provides a simple, intuitive, or efficient user interface for reading the electronic book.

### SUMMARY

An electronic book reading apparatus is provided. The electronic book reading apparatus mainly includes a user interface, an operation controlling unit, and a display unit. The user interface is for allowing a user to intuitively flip an appropriate number of pages of a displayed electronic book. The user interface includes a plurality of sensing units for generating sensing signals in response to the user's flipping operations. The sensing units are respectively designated a coordinate for identifying itself. The operation controlling unit is for determining a direction of the flipping operations and generating a direction signal according to the sensing signals. The display unit is for receiving the direction signal, flipping the appropriate number of pages of the electronic book in a corresponding direction according to the received direction signal, and displaying the resulting page of the electronic book after flipping.

Other advantages and novel features will be drawn from the following detailed description with reference to the attached drawing, in which:

### BRIEF DESCRIPTION OF DRAWINGS

FIG. 1 is a schematic diagram of hardware infrastructure of an electronic book reading apparatus in accordance with a preferred embodiment of the present invention; and

FIG. 2 is an exemplary schematic diagram illustrating a reading operation on an electronic book by utilizing the apparatus of FIG. 1.

### DETAILED DESCRIPTION

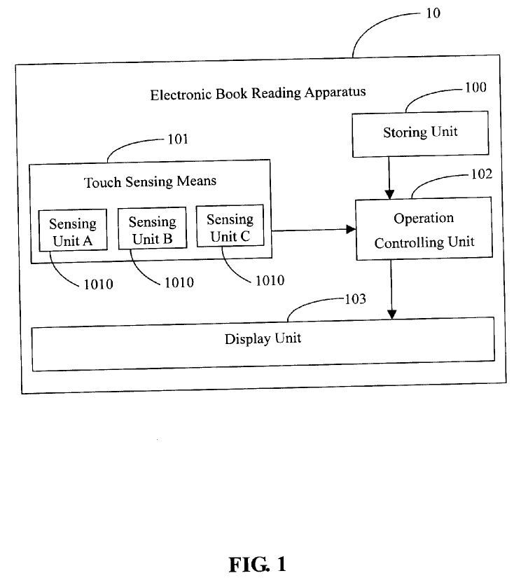

FIG. 1 is a schematic diagram of hardware infrastructure of an electronic book reading apparatus (hereinafter, “the apparatus”) in accordance with a preferred embodiment of the present invention. The apparatus 10 mainly includes a storing unit 100, a user interface 101, an operation controlling unit 102, and a display unit 103.

The storing unit 100 is provided for storing electronic books. The user interface 101 is provided for allowing the user to intuitively flip an appropriate number of pages of a displayed electronic book 11 in a desired direction. Therefore, the user interface 101 is preferably designed with a touch sensing interface. Accordingly, in the preferred embodiment, a touch sensing means is designated as the user interface 101. The touch sensing means 101 includes a plurality of sensing units 1010 (only three shown and symbolically designated as sensing unit ‘A’, sensing unit ‘B’, and sensing unit ‘C’). The sensing units 1010 are capable of generating sensing signals in response to the user's flipping operations. Further, each sensing unit 1010 is designated a coordinate for identifying itself.

The operation controlling unit 102 is provided for scanning the sensing units 1010, detecting which sensing units 1010 generate sensing signals (that is, which sensing units 1010 are touched or stroked), and determining a corresponding signal generating sequence among the detected sensing units 1010, thus determining a direction of the user's flipping operational inputs according to the signal generating sequence of the detected sensing units 1010 to generate a corresponding direction signal.

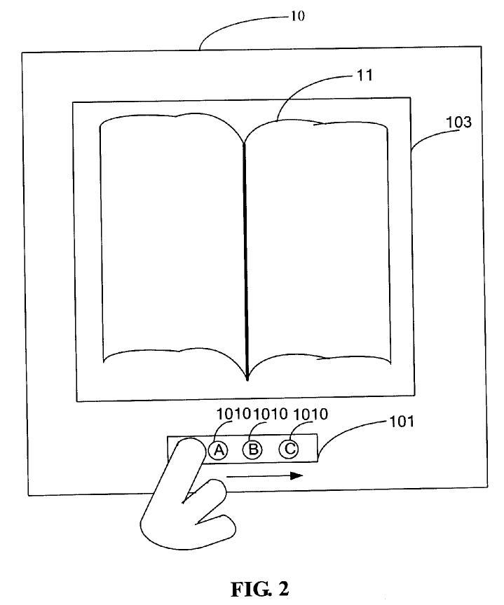

For example, if the sensing unit ‘A’ is first touched, then the sensing unit ‘B’, and followed by the sensing unit ‘C’, the direction of the user's flipping operations (referred to FIG. 2) is determined as towards right and indicated by the corresponding direction signal (e.g., symbolically designated as direction signal ‘d1’); likewise, if the sensing unit ‘C’ is first touched, then the sensing unit ‘B’, and followed by the sensing unit ‘C’, the direction of the user's flipping operations (referred to FIG. 2) is determined as towards left and indicated by the corresponding direction signal (e.g., symbolically designated as direction signal ‘d2’).

Consequently, the display unit 103 flips the appropriate number of pages of the displayed electronic book 11 in a corresponding direction according to the direction signal from the operation controlling unit 102, and displays the resulting page of the electronic book 11 after flipping. For example, when the direction signal is the direction signal ‘d1’, the display unit 103 flips the appropriate number pages of the displayed electronic book 11 from left to right; when the direction signal is the direction signal ‘d2’, the display unit 103 flips the appropriate number pages of the displayed electronic book 11 from right to left, and displays the resulting page of the electronic book after flipping. Therefore, by utilizing the touch sensing means as the user interface, the user can intuitively and efficiently flip an appropriate number of pages of the displayed electronic book 11 in a desired direction that mimics the action one does when reading a paper book.

FIG. 2 is an exemplary schematic diagram illustrating a reading operation on an electronic book by utilizing the apparatus of FIG. 1. As described above, the touch sensing means provides a plurality of sensing units 1010 (i.e., sensing unit ‘A’, sensing unit ‘B’, and sensing unit ‘C’) for generating sensing signals in response to the user's flipping operations. Accordingly, as the user strokes the touch sensing means in a direction of right, the page of the displayed electronic book 11 is turned in the same direction. Thus, by utilizing the apparatus 10, the user intuitively, efficiently flips the displayed electronic book 11 in his or her desired direction.

Although the present invention has been specifically described on the basis of a preferred embodiment thereof, the invention is not to be construed as being limited thereto. Various changes or modifications may be made to the embodiments without departing from the scope and spirit of the invention.

What is claimed is:

1. An electronic book reading apparatus comprising:
a user interface allowing a user to flip an appropriate number of pages of a displayed electronic book, the user interface comprising a plurality of sensing units for generating sensing signals in response to the user's flipping operations;
an operation controlling unit for determining a direction of the flipping operations and generating a direction signal according to the sensing signals; and
a display unit for receiving the direction signal, flipping the appropriate number of pages of the displayed electronic book in a corresponding direction according to the received direction signal, and displaying the resulting page of the electronic book after flipping.

2. The electronic book reading apparatus according to claim 1, further comprising a storing unit for storing the electronic book.

3. The electronic book reading apparatus according to claim 2, wherein each of the sensing units is designated a coordinate for identification.

4. The electronic book reading apparatus according to claim 3, wherein the operation controlling unit determines the direction of the flipping operations according to the coordinates of the sensing units which generate the sensing signals.
